(19) United States
(12) Patent Application Publication
(10) Pub. No.: US 2026/0032368 A1
(43) Pub. Date: Jan. 29, 2026

(54) HEADSET WITH ADJUSTABLE MICROPHONE SUPPORT ARM

(71) Applicant: Shure Acquisition Holdings, Inc., Niles, IL (US)

(72) Inventors: Dustin Smith, Libertyville, IL (US); John Matthew Miller, Grayslake, IL (US); Yuheng Wu, Suzhou (CN); Peter Hu, Suzhou (CN)

(21) Appl. No.: 18/784,341

(22) Filed: Jul. 25, 2024

(51) Int. Cl. H04R 1/02

(52) U.S. Cl. CPC H04R 1/021; H04R 2201/02

(57) ABSTRACT

A headset microphone may comprise a microphone at the end of a boom arm that may be adjustably secured in a number of positions. The number of positions may be selected by a user, and may be arranged to accommodate a wide variety of users. The headset may comprise a frame and a post configured to receive a slider. The slider may receive a boom arm retaining the microphone. The frame and the post may comprise respective channels defined by the shape of the slider. The headset may comprise a knob, which may secure the slider in order to fix the slider in a number of positions on the headset.

### FIELD

The present disclosure relates generally to an adjustable microphone headset of the type used in connection with communications, recording and broadcasting systems.

### BACKGROUND

Headsets permit the use of a microphone and/or earphones while providing a user freedom to use his or her hands while speaking. In many instances, use of a hands-free communication device may be desired for various multitasking purposes. Headsets may require adjustments by the user during each use of the headset or when switching from one user to the next (e.g., to position the microphone in a desirable location relative to the user's mouth).

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

Aspects of the disclosure pertain to a headset having an adjustable boom arm for accommodating a variety of wearers. The headset may also include a slider for receiving a boom arm retaining a microphone. The headset may also include a boom arm frame for receiving the slider and having a channel profile that corresponds to the slider. The slider may be operable to bidirectionally reciprocate through the boom arm frame to a number of positions. The headset may further include a post, a knob, and a washer configured to secure the boom arm clip in a number of positions on the headset to accommodate for different sized users and/or optimize the performance of the microphone.

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates a perspective view of an example headset.

FIG. 2 illustrates an exploded perspective view of the example headset of FIG. 1

FIG. 3 illustrates an exploded perspective view of selected components of the example headset of FIG. 1.

FIG. 4 illustrates a close-up perspective view of the example headset of FIG. 1.

FIG. 5 illustrates a perspective view of selected components of the example headset of FIG. 1.

FIG. 6 illustrates an exploded perspective view of selected components of the example headset of FIG. 1.

FIG. 7 illustrates a perspective view of selected components of the example headset of FIG. 1.

FIGS. 8a-8d illustrate side views of various components of the example headset of FIG. 1.

FIG. 9 illustrates a perspective view of the example headset of FIG. 1 in an extended position.

FIG. 10 illustrates a perspective view of the example headset of FIG. 1 in a retracted position.

FIG. 11a illustrates a perspective view of selected components of the example headset of FIG. 1.

FIG. 11b illustrates a perspective view of selected components of the example headset of FIG. 1.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

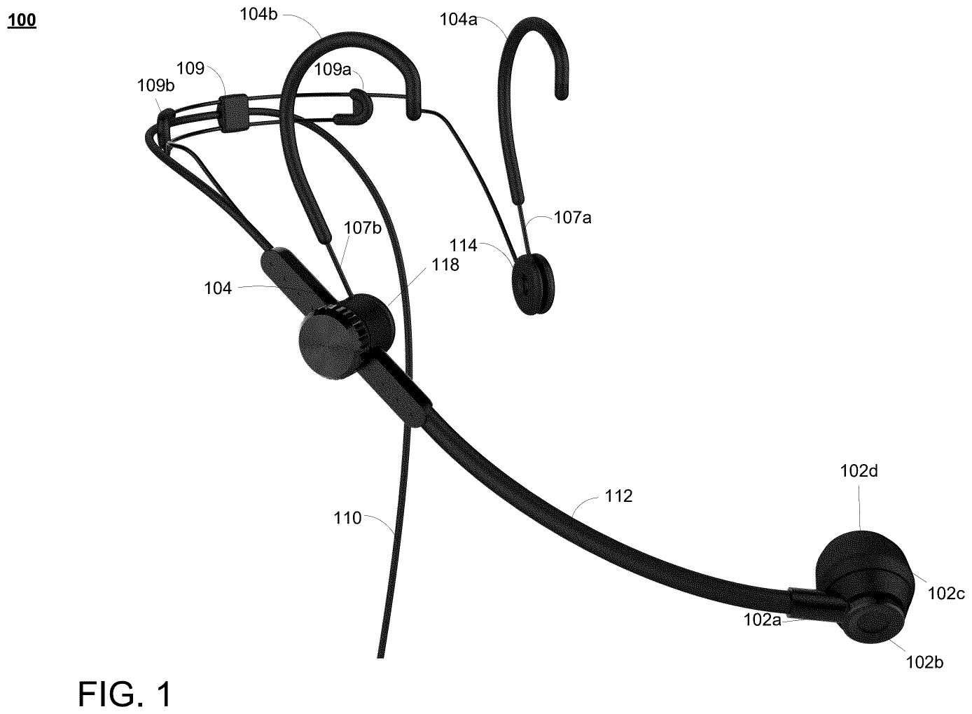

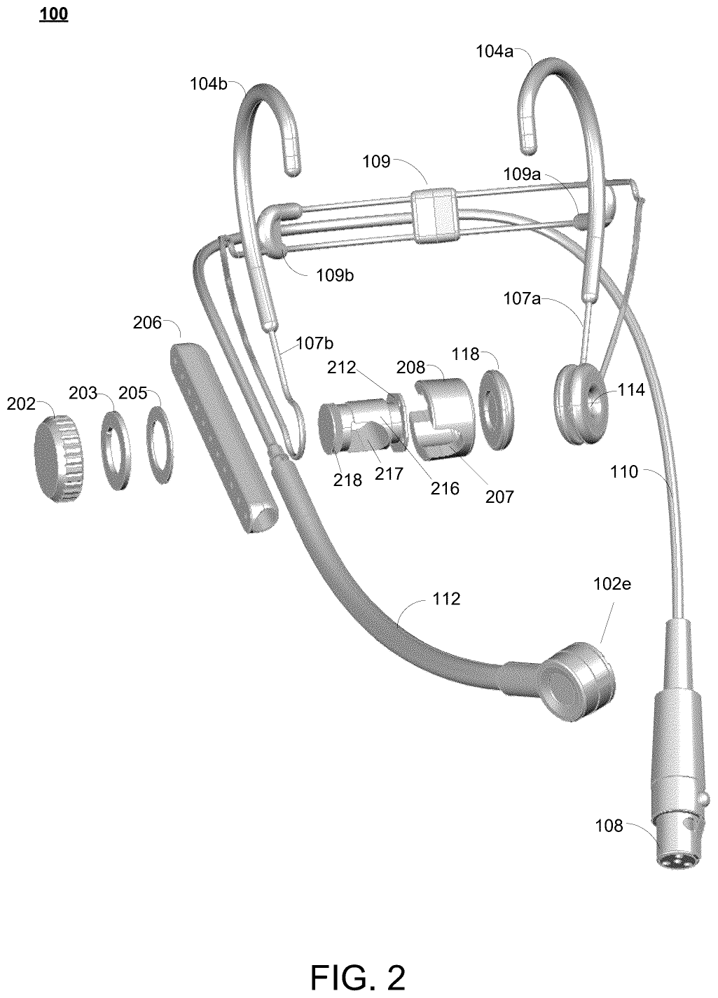

FIG. 1 illustrates a perspective view of an example headset 100, and FIG. 2 shows an exploded view of the example headset. Headset 100 may include an adjustable wire or cable cinch 109 with a pair of adjustable cinches 109a, 109b, a pair of headset wires 107a, 107b, a pair of earhooks or ear hangers 104a, 104b, a grommet 114 for securing headset wire 107a, gooseneck jacket 112 (or boom arm 112) for receiving microphone housing 102 and microphone cable 110, a microphone cable connector 108 (shown in FIG. 2), and an adjustment mechanism 104 for adjusting the position of the gooseneck jacket 112 and microphone housing 102a. Shaft overmold 118 may secure headset wire 107b. Microphone housing 102a may include microphone mesh insert 102b, windscreen collar 102c, windscreen 102d, and a microphone capsule 102e (shown in FIG. 2).

Microphone capsule 102e may include any type of microphone capsule, such as condenser (e.g., including large- and small-diaphragm and electret condenser), dynamic (i.e., including moving coil and ribbon microphones), and/or micro-electromechanical systems (MEMS), among others. The microphone capsules may be constructed according to one or more geometries (e.g., round, oval, elliptical, rectangular, etc.). Connector 108 may be one of a variety of different connectors, such as a LEMO connector, an XLR connector, a Lightning® connector, a TQG connector, a TRS connector, a USB connector (including, but not limited to, USB type A, type B, type C, Mini B, Micro B), and/or one or more RCA connectors. Connector 108 may connect microphone 102e with a component of a wireless microphone system, such as, for example, a wireless transmitter.

Referring to FIG. 2, adjustment mechanism 104 may include knob 202, O-ring or washers 203, 205, slider 206, boom arm frame 208 (or simply “frame 208”), and shaft overmold 118. Slider 206 may include a hollow channel 207. Channel 207 may receive cable 110 and/or gooseneck jacket 112. Cable 110 may pass through channel 207 and through gooseneck jacket 112 to connect to microphone 102. Washers 203, 205 and knob 202 may share similar geometric characteristics (e.g., the shape of washers 203, 205 and knob 202 may be substantially similar, the geometry of washers 203, 205 and knob 202 may be equivalent, etc.). Adjustment mechanism 104 may include fewer or more washers 203, 205. That is, adjustment mechanism may include more than one washer 203 and more than one washer 205. Adjustment mechanism may include either one washer 203 or one washer 205. Washers 203, 205 may be constructed according to different thicknesses and overall dimensions. Washers 203, 205 may be constructed according to equivalent thicknesses and overall dimensions. Washers 203, 205 may be configured as gaskets or O-rings. Washers 203, 205 may be composed of rubber, any number of thermoplastics, and/or metal, etc. Frame 208 may be configured with a lip (not shown) that may help prevent slider 206 from rotating and may help keep adjustment mechanism 104, and, specifically, slider 206, in a desired orientation.

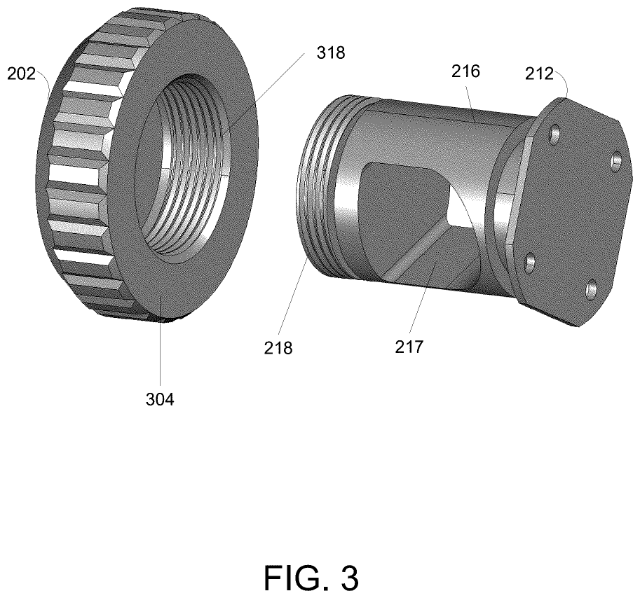

As will be discussed in more detail below, base 212 may include post 216. Post 216 may be integrally molded to base 212. Post 216 may include threads 218, which may correspond to threads 318 of knob 202 (shown in FIG. 3). A user may loosen or tighten the connection between threads 218 and 318, which may consequently reduce or increase the force, respectively, that washers 203, 205 may apply on slider 206. As a result of loosening threads 218 and 318, slider 206 may axially reciprocate (that is, move bidirectionally on the axis defined by gooseneck jacket 112 and/or cable 110) with respect to the remaining components of adjustment mechanism 104. As a result of sufficiently tightening the connection between threads 218 and 318, slider 206 may be securely fixed in a desired position. In this way, gooseneck jacket 112 is adjustable to accommodate a variety of users. It will be appreciated that any number of connecting mechanisms may be employed without necessarily departing from the scope of this disclosure. For example, connection methods other than threads 218 and 318 may be employed to allow post 216 and knob 202 to securely connect with one another, such as a ball and pin arrangement, a detent pin, a spring-loaded fastener, a spring-loaded dowel, a spring-loaded plunger configuration, etc.

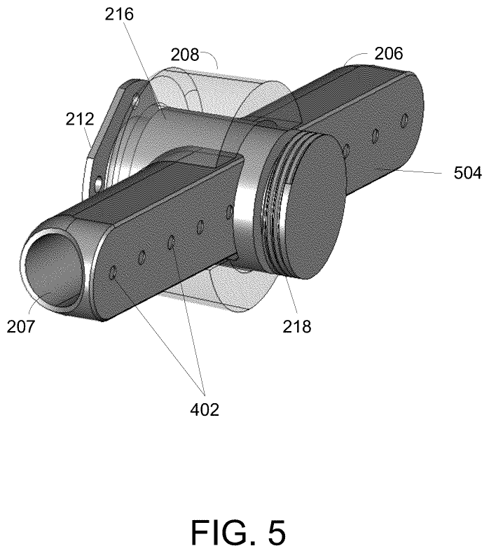

Referring to FIG. 3, knob 202 may include threads 318 that correspond to threads 218 of post 216. Threads 318 may be recessed into knob 202. Knob 202 may include face 304 that may be substantially flat. Face 304 may interface with washers 203, 205 and face 504 of slider (shown in FIG. 5) to secure slider 206 in a desired position as described herein.

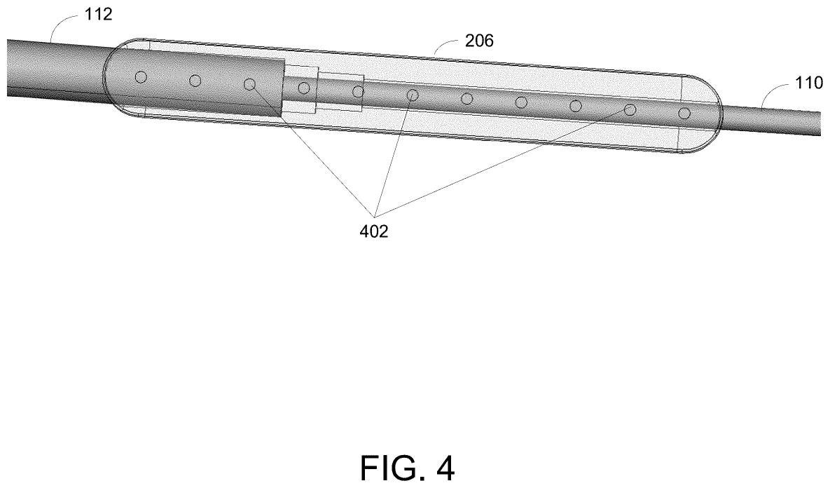

As shown in FIG. 4, gooseneck jacket 112, in an example, may be integrally formed with slider 206. As discussed, slider 206 may include channel 207 such that cable 110 may pass through slider 206 and connect to microphone 102. Similarly, in an example, cable 110 may be integrally formed with gooseneck jacket 112. In operation, translation (or movement) of slider 206 through adjustment mechanism 104 may also cause similar movement of gooseneck jacket 112 and cable 110. In other words, gooseneck jacket 112, boom arm 206, and cable 110 may be integrally formed with one another such that the three components move in unison when a user adjusts slider 206 within adjustment mechanism 104 as described herein. Slider may include a plurality of indicators 402. Indicators 402 may be embossed or debossed on the surface of slider 206 (e.g., on face 504 as illustrated in FIG. 5). In the latter case, indicators 402 may be referred to as detents 402. Indicators 402 may provide a reliable measure to a user of the suitable position of slider 206.

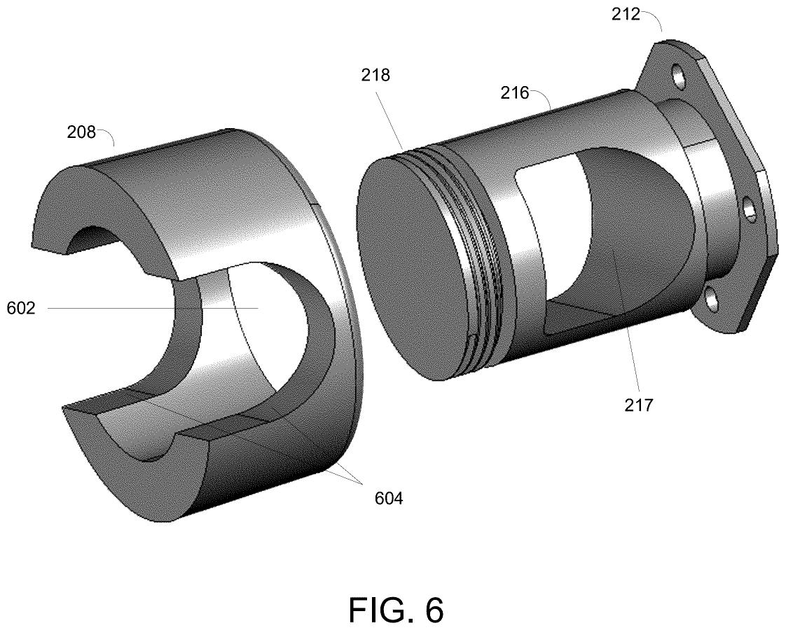

FIG. 5 illustrates in greater detail the interface among several components of adjustment mechanism 104. Frame 208 (transparent) and post 216 may be configured such that slider 206 may traverse, or reciprocate, through post 216 and frame 208. Frame 208 may include an opening (opening 602 of FIG. 6) through which post 216 may extend so that threads 218 may engage with knob 202 (not shown). Frame 208 and post 216 may include respective channels (channels 604 and 217, respectively, as shown in FIG. 6) that may be configured to receive slider 206 and allow slider 206 to bidirectionally reciprocate trough said channels.

As further illustrated by FIG. 5, post 216 may extend outwardly past face 504 of slider 206 and frame 208. Washers 203, 205 (not shown) may be positioned around post 216 and between face 504 of slider 206 and knob 202 (not shown). Face 504 may be substantially flat with respect to washers 203 and/or 205, which may increase the points of contact between the two components (e.g., may maximize the surface area of face 504 that washers 203 and/or 205 contact when knob 202 is tightened). As discussed above, knob 202 may be fastened to threads 218 of post 216 to securely fix slider 206 in place in order to position gooseneck jacket 112 and microphone 102 in a desired orientation relative to a user's mouth. In operation, as knob 202 is increasingly threaded onto threads 218 toward slider 206, washers 203, 205 may exert an increasing force against face 504. Knob 202 may be unthreaded from threads 218, which may consequently reduce the force of washers 203, 205 against slider 206 and allow a user to slide slider 206 to a desired position.

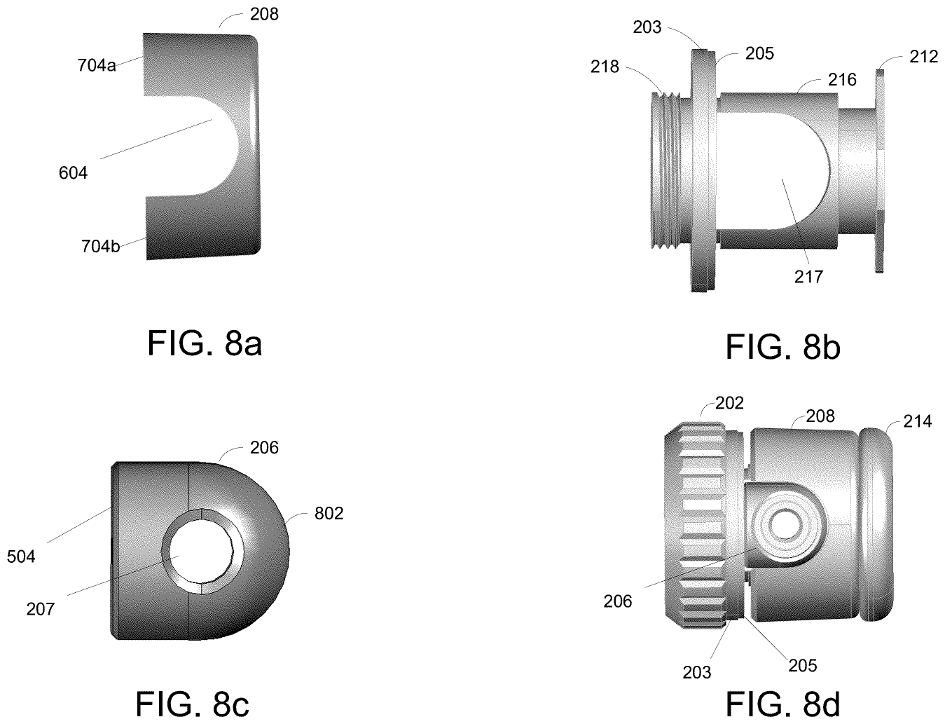

FIG. 6 illustrates in greater detail several components of adjustment mechanism 104, in particular frame 208 and base 212. Specifically, post 216 of base 212 may provide channel 217 through which slider 206 may traverse, or reciprocate. Channel 217 may extend through post 216 along a horizontal axis (e.g., an axis perpendicular to the axis that passes through the midpoint of post 216). As discussed above, post 216 may include threads 218 that may correspond to threads 318 of knob 202. Frame 208 may include an opening 602 through which post 216 and channel 217 may extend. Frame 208 may include a channel 604 through which slider 206 may traverse. Channel 604 may extend perpendicularly to a vertical axis defined by frame 208. Frame 208 may be substantially cylindrical. The geometry of channel 604 may be substantially similar to the shape of the outer profile slider 206. Similarly, the geometry of channel 217 may be substantially similar to the shape of the outer profile of slider 206. Stated differently, channel 604 and channel 217 may each have a profile that corresponds to the outer profile of slider 206, as illustrated in FIGS. 8a-8d.

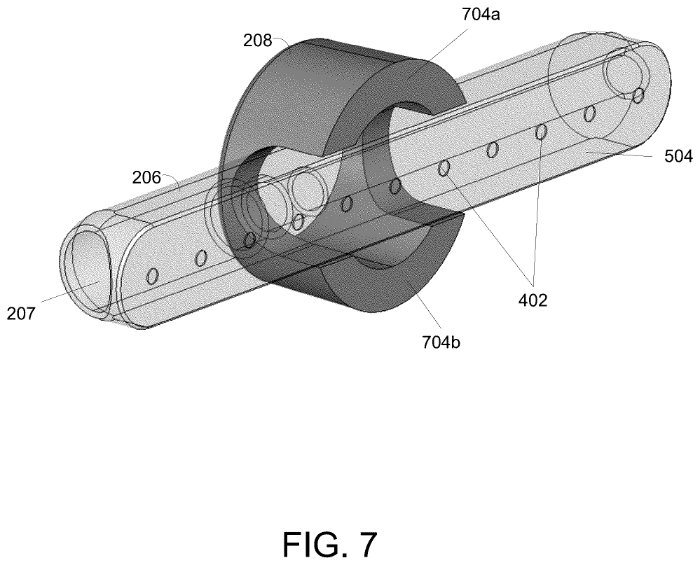

FIG. 7 illustrates in greater detail the interface between slider 206 (transparent) and frame 208. As shown, slider 206 may be seated within frame 208 (e.g., in channel 604) during operation of headset 100. When fully seated in frame 208, face 504 of slider 206 may be substantially flush with faces 704a and 704b of frame 208. As the adjustment mechanism 104 is loosened, slider 206 may move bidirectionally through channel 604 to adjust gooseneck jacket 112 to a desired position.

FIGS. 8a-8d illustrate side views of several components of adjustment mechanism 104. As has been discussed, channel 604 and channel 217 may each have a profile that corresponds to the outer profile of slider 206. As shown in FIG. 8a, channel 604 may have a substantially “D-shaped” profile. Similarly, as shown in FIG. 8b, channel 217 may have a substantially “D-shaped” profile. And as illustrated by FIG. 8c, slider 206 may also have a substantially “D-shaped” profile as defined by face 504 (which may be substantially flat) and region 802 (which may be arcuate). It will be appreciated that slider 206 may be configured according to a number of geometries (e.g., slider 206 may be configured with a variety of profiles) without departing from the scope of this disclosure. For example, slider 206 may have an outer profile approximating many shapes, such as a triangle, a square, a rectangle, an oval, a circle, etc. Accordingly, channels 217 and 604 may also be configured according to any number of geometries. FIG. 8d illustrates an example configuration wherein knob 202 is threaded onto post 216 in order to secure slider 206 on the headset 100. In this configuration, slider 206 may be seated (e.g., flushly seated) within channels 604 and 217 during operation of headset 100 such that face 504 of slider 206 contacts washers 203, 205 as knob 202 is threaded onto threads 218. The user may adjust slider 206 without removing headset 100 from the user's head.

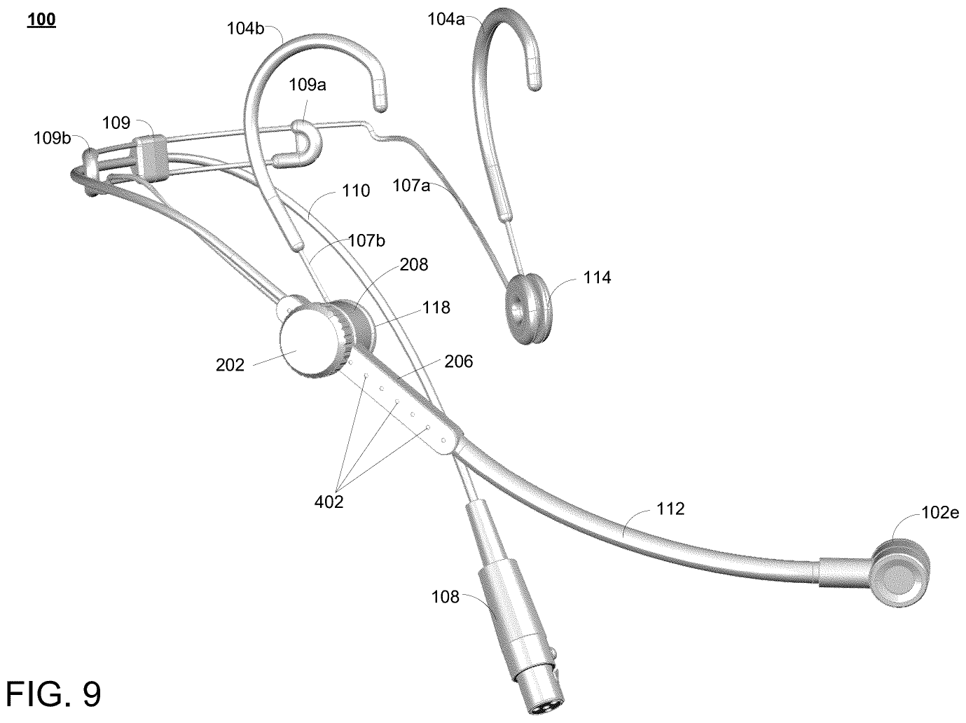

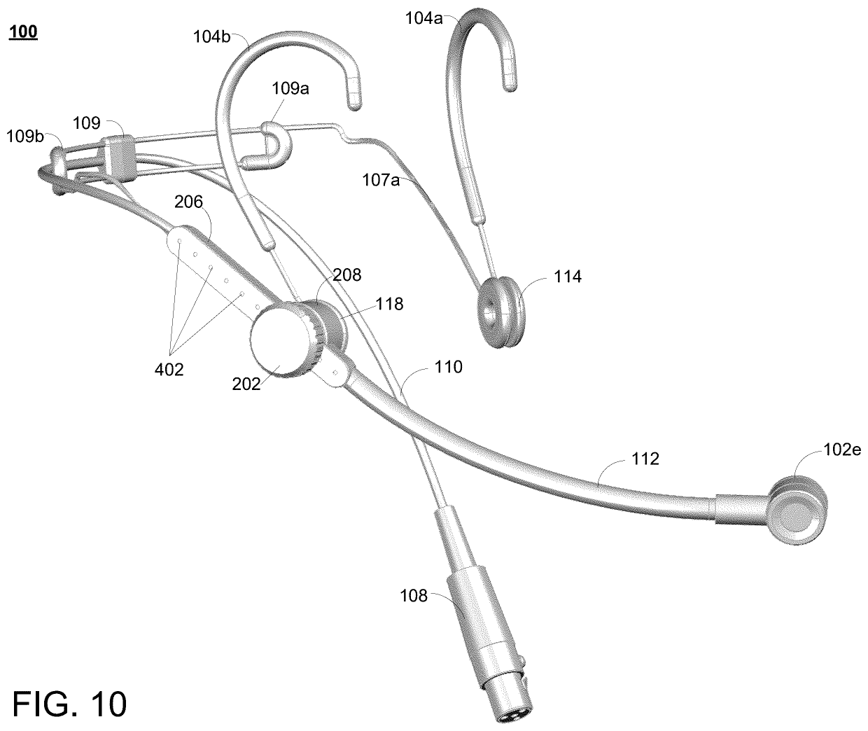

Headset 100 may be adjustable to accommodate a variety of users. FIGS. 9 and 10 illustrate slider 206 fixed in various positions to accommodate a wide variety of users. FIG. 9 depicts slider 206 in one of many extended positions. FIG. 10 depicts slider 206 in one of many retracted positions. As discussed herein, slider may include a plurality of indicators 402. Indicators 402 may be embossed or debossed on the surface of slider 206 (e.g., on face 504). Indicators 402 may provide a reliable measure to a user of the suitable position of slider 206. For example, headset 100 is worn by User A and User B. User A prefers slider 206 to be extended such that seven indicators 402 are showing in front of adjustment mechanism 104 (that is, proximal to microphone 102). User B prefers slider 206 to be retracted such that one indicator 402 is showing in front of adjustment mechanism. In this way, indicators 402 may provide a reliable, reproducible and quick method to adjust the position of gooseneck jacket 112 and microphone 102. Slider 206 may include any number of indicators 402. Indicators 402 may be spaced at a number of increments (or distances) apart from one another. Headset 100 may be configured in a “right-side” and a “left-side” configuration. For example, in a “right-side” configuration, capsule 102e, boom arm 112, adjustment mechanism 104, etc., may be disposed on the right side of a user's face, on the same side as ear hook 104b. In a “left-side” configuration, capsule 102e, boom arm 112, adjustment mechanism 104, etc., may be disposed on the left side of a user's face, for example, on the same side as ear hook 104a.

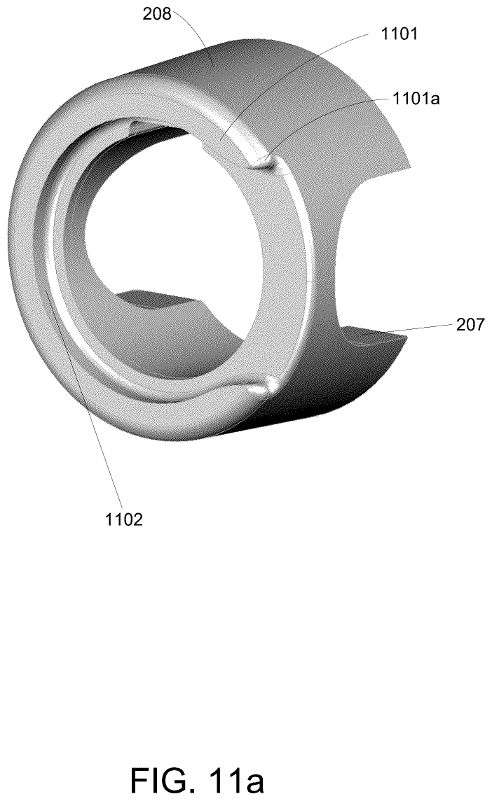

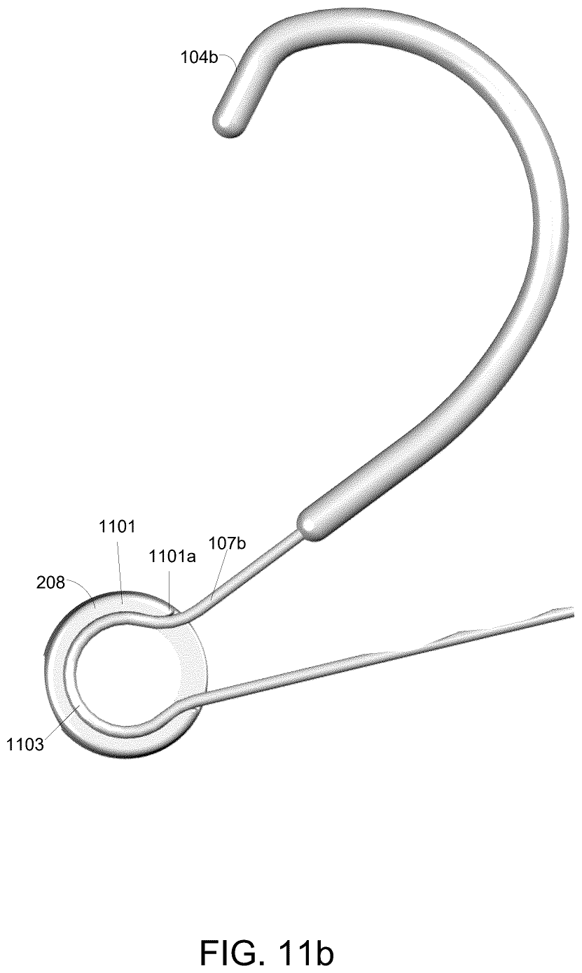

FIG. 11a illustrates a close-up perspective view of frame 208. FIG. 11b illustrates a perspective view of selected components of the example headset of FIG. 1, including wire 107b, frame 208, and notch 1103. Referring to FIG. 11a, frame 208 may include ridge 1101. Ridge 1101 may be integral to frame 208. Ridge 1101 may include terminal end 1101a. End 1101a may be configured to help prevent slider 206 from rotating about an axis defined by the midpoint of opening 602 of frame 208 (FIG. 6). End 1101a may help lock slider 206 in a single orientation with respect to other components of adjustment mechanism 104. Ridge 1101 may protrude from frame 208 and may define notch 1102. Notch 1102 may be configured to receive and couple with wire 107b. Notch 1102 may help lock wire 107b in place. Referring to FIG. 11b, wire 107b may include segment 1103. Segment 1103 may be integral to wire 107b. Segment 1103 may be constructed with an arcuate geometry. Segment 1103 may be constructed with a geometry that corresponds to and/or complements that of notch 1102. Notch 1102 may receive and couple with segment 1103 such that segment 1103 may be rotatably and/or adjustably fixed within notch 1102. Notch 1102 may receive and couple with segment 1103 such that segment 1103 may be fixed or non-moving relative to one another.

Wire 107b may provide structural support for ear hook 104b. Segment 1103 of wire 107b may engage with notch 1102 of frame 208 to lock wire 107b in a fixed position with respect to adjustment mechanism 104. Notch 1102 may help prevent wire 107b from rotating about an axis defined by the midpoint of opening 602 (FIG. 6) of frame 208 as a user manipulates slider 206 (such as, for example, from a first position to a second position) and/or other components of adjustment mechanism 104. The fixed nature of segment 1103 of wire 107b may help prevent ear hook 104b from slipping off a user's ear as the user manipulates slider 206 and/or other components of adjustment mechanism 104. The fit between segment 1103 and notch 1102 may also help ensure that microphone capsule 102e remains in a desired position with respect to a user's mouth as the user manipulates slider 206 and/or other components of adjustment mechanism 104.

It will be appreciated that slider 206 may move bidirectionally through adjustment mechanism 104 according to a number of different configurations. For example, adjustment mechanism may include such other components such as a ratchet assembly (not shown) to secure slider 206 in a desired position and to allow movement of slider 206; and/or, in the case of a spring-loaded plunger configuration, knob 202 may include a pin that engages with detents 402 of slider 206 to secure slider 206 in a desired position. In the foregoing specification, the present disclosure has been described with reference to specific exemplary examples thereof.

A headset for a microphone may comprise a base, a frame, and/or a knob. The base may comprise a post extending from the base. The post may comprise a first channel configured to receive a slider affixed to a boom arm. The frame may comprise: an opening configured to receive the post; and a second channel configured to receive the slider. The knob may be configured to engage with the post and to secure the slider in the second channel of the frame. The headset may further comprise a washer disposed between the slider and the knob and configured to exert a force against the slider when the knob is tightened to the post to secure the slider in the frame. The slider may further comprise a plurality of detents configured to indicate a position of the slider relative to the knob. A first inner profile of the opening of the post may correspond to an outer profile of the slider. A second inner profile of the second channel of the frame may correspond to an outer profile of the slider. The second inner profile of the second channel of the frame may be configured as a D-shaped profile. The post and the knob may have mating threads.

A headset for a microphone may comprise a slider, a frame, and/or a knob. The slider may be affixed to a boom arm. The frame may comprise a first channel configured to receive the slider. The knob may be configured to secure the slider in the frame. The first channel of the frame may comprise a first inner profile that corresponds to an outer profile of the slider. The headset may further comprise a base comprising a post extending from the base. The post may comprise a second channel configured to receive the slider. The frame may further comprise an opening configured to receive the post. The knob may be configured to engage with the post. The post and the knob may have mating threads. A second inner profile of the second channel of the post may correspond to an outer profile of the slider. A first inner profile of the first channel of the frame may be configured as a D-shaped profile. The headset may further comprise a base comprising a post extending from the base, wherein the post comprises a second channel configured to receive the slider. The headset may further comprise a washer disposed between the slider and the knob and configured to exert a force against the slider when the knob is tightened to the post.

A headset for a microphone may comprise a slider and a frame. The slider may be affixed to a boom arm. The frame may comprise a first channel. The first channel may define an axis, wherein the frame may be configured to receive the slider, and wherein the slider may be configured to translate from a first position to a second position in the frame along the axis defined by the first channel. The headset may comprise a base comprising a post extending from the base, wherein the post may comprise a second channel configured to receive the slider. The headset may comprise a knob configured to engage with the post and to secure the boom arm in the second channel of the frame. The frame may further comprise a first opening configured to receive the post. The post and the knob may have mating threads. The first channel of the frame may comprise a first inner profile. The slider may comprise an outer profile. The first inner profile of the first channel of the frame may correspond to the outer profile of the slider. The slider may further comprises a plurality of detents configured to indicate a position of the slider relative to a knob.

Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrated rather than restrictive sense. Accordingly, it is not intended that the invention be limited except as may be necessary in view of the appended claims.

1. A headset for a microphone comprising:
a base comprising a post extending from the base, wherein the post comprises a first channel configured to receive a slider affixed to a boom arm;
a frame comprising:
an opening configured to receive the post; and
a second channel configured to receive the slider; and
a knob configured to engage with the post and to secure the slider in the second channel of the frame.

2. The headset of claim 1, further comprising a washer disposed between the slider and the knob and configured to exert a force against the slider when the knob is tightened to the post to secure the slider in the frame.

3. The headset of claim 1, wherein the slider further comprises a plurality of detents configured to indicate a position of the slider relative to the knob.

4. The headset of claim 1, wherein a first inner profile of the opening of the post corresponds to an outer profile of the slider.

5. The headset of claim 1, wherein a second inner profile of the second channel of the frame corresponds to an outer profile of the slider.

6. The headset of claim 5, wherein the second inner profile of the second channel of the frame is configured as a D-shaped profile.

7. The headset of claim 1, wherein the post and the knob have mating threads.

8. A headset for a microphone comprising:
a slider affixed to a boom arm;
a frame comprising a first channel configured to receive the slider; and
a knob configured to secure the slider in the frame.

9. The headset of claim 8, wherein the first channel of the frame comprises a first inner profile that corresponds to an outer profile of the slider.

10. The headset of claim 8, further comprising a base comprising a post extending from the base, wherein the post comprises a second channel configured to receive the slider, wherein the frame further comprises an opening configured to receive the post, and wherein the knob is further configured to engage with the post.

11. The headset of claim 10, wherein the post and the knob have mating threads.

12. The headset of claim 10, wherein a second inner profile of the second channel of the post corresponds to an outer profile of the slider.

13. The headset of claim 8, wherein a first inner profile of the first channel of the frame is configured as a D-shaped profile.

14. The headset of claim 8, further comprising a base comprising a post extending from the base, wherein the post comprises a second channel configured to receive the slider.

15. The headset of claim 8, further comprising a washer disposed between the slider and the knob and configured to exert a force against the slider when the knob is tightened to the post.

16. A headset for a microphone comprising:
a slider affixed to a boom arm; and
a frame comprising a first channel, wherein the first channel defines an axis, wherein the frame is configured to receive the slider, and wherein the slider is configured to translate from a first position to a second position in the frame along the axis defined by the first channel.

17. The headset of claim 16, further comprising:
a base comprising a post extending from the base, wherein the post comprises a second channel configured to receive the slider; and
a knob configured to engage with the post and to secure the boom arm in the second channel of the frame; and
wherein the frame further comprises a first opening configured to receive the post.

18. The headset of claim 17, wherein the post and the knob have mating threads.

19. The headset of claim 16, wherein:
the first channel of the frame comprises a first inner profile;
the slider comprises an outer profile; and
the first inner profile of the first channel of the frame corresponds to the outer profile of the slider.

20. The headset of claim 16, wherein the slider further comprises a plurality of detents configured to indicate a position of the slider relative to a knob.
